(19) United States
(12) Patent Application Publication
(10) Pub. No.: US 2008/0225028 A1
(43) Pub. Date: Sep. 18, 2008

(54) Method for Driving a Light Emitting Tube Array

(76) Inventors: Hitoshi Hirakawa, Hyogo (JP); Manabu Ishimoto, Hyogo (JP); Kenji Awamoto, Hyogo (JP)

Correspondence Address: STAAS & HALSEY LLP, SUITE 700, 1201 NEW YORK AVENUE, N.W., WASHINGTON, DC, 20005, US

(21) Appl. No.: 12/065,048

(22) PCT Filed: Sep. 1, 2005
(86) PCT No.: PCT/JP2005/016010

§ 371 Date: Mar. 25, 2008

(51) Int. Cl. G06F 3/038

(52) U.S. Cl. 345/206

(57) ABSTRACT

A light emitting tube array drivable in an ADS subfield mode wherein a fluorescent material layer is arranged on an inner wall of each light emitting tube sandwiched between a front substrate and a rear substrate, a discharge gas is airtightly put therein, and a plurality of electrodes formed for generating discharge in the light emitting tube are formed on the front substrate and the rear substrate has a problem that a discharge error is caused so that its cells wherein light emission should be caused do not emit light since the volume of its discharge spaces is extremely larger than that in plasma display panels or since the discharge spaces are partitioned by the light emitting tubes. The inventors have invented a method for driving a light emitting tube array, which has a structure as above described, drivable in an ADS subfield mode, wherein the electric potential of a first pulse in a sustain term and the width thereof, which corresponds to the applying time of the pulse, are appropriately set, thereby preventing the discharge error.

### TECHNICAL FIELD

The present invention relates to a driving method for causing a light emitting tube array to realize display having a high display quality, the array being an array wherein a plurality of slender light emitting tubes are arranged in parallel to each other to generate electric discharge in the light emitting tubes, thereby attaining display.

### BACKGROUND ART

As the background of the present invention, a structure which is a recent main current of light emitting tube arrays is first described with reference to FIG. 1. A light emitting tube array 1 has a structure wherein a plurality of light emitting tubes 13 are sandwiched between a front substrate 11 and a rear substrate 12. On the front substrate 11, a plurality of display electrodes 14x and display electrodes 14y are arranged. One of the display electrodes 14x and one of the display electrodes 14y constitute a pair, and have a function of generating plane discharge between this electrode pair.

On the rear substrate 12, a plurality of address electrodes 15 are formed in a direction perpendicular to the display electrodes 14x formed on the front substrate 11. In each of the light emitting tubes 13, a protecting film (21 in FIG. 2) of an MgO film, not illustrated in FIG. 1, is formed at the side of its inner wall facing the display electrodes 14x and 14y. On each of the inner walls of the light emitting tubes 13 at the rear substrate 12 side thereof, a fluorescent material layer (22 in FIG. 2), which is not illustrated in FIG. 1, is formed. About the fluorescent material layer, each of the light emitting tubes 13 is coated with a red, green or blue fluorescent material. In some cases, the fluorescent material is painted in advance onto a different slender member called board (23 in FIG. 2), and then the resultant is inserted into the light emitting tube 13. Both ends of the light emitting tube 13 are sealed up, and Ne—Xe gas is airtightly put in the inside thereof, which will become a discharge space.

FIG. 2 illustrates a situation of the discharge space (that may be called light emitting region or cell), which is viewed from its cross section obtained by cutting the light emitting tube 13 in the longitudinal direction. When a voltage is applied to two adjacent electrodes out of the display electrodes 14x and 14y, an electric discharge 24 is generated in the region (cell) in the light emitting tube 13 so that Xe put airtightly in the discharge space is excited to emit vacuum ultraviolet rays 25. When the vacuum ultraviolet rays 25 are radiated onto a fluorescent material 22 painted in advance on a board 23 of the light emitting tube 13, visible rays 26 are emitted. When a voltage is applied to the display electrode pairs 14, which correspond to cells which are discharge spaces (light emitting regions) in the light emitting tubes 13, the vacuum ultraviolet rays 25 are controlled to emit the visible rays 26, in such a way, the array acts as a display.

As methods for driving the light emitting tube array 1 having the above-mentioned structure, the same methods for driving plasma display panels have been generally used. A main current driving method thereof is described with reference to FIG. 3. At the time of performing driving in an ADS subfield mode, which is generally used to realize gradation display, the display electrodes 14y are successively scanned in an address term Ta shown in FIG. 3 while the address electrodes 15 are selectively driven in a line-at-a-time manner. In a sustain term Ts, alternating maintenance pulses are supplied to the display electrode pairs 14 all at once, so as to attain display. For reference, Tr in FIG. 3 is a term called a reset term, and has a function of adjusting the wall charge amount on the display electrodes 14y or the address electrodes 15 into an appropriate amount.

### DISCLOSURE OF THE INVENTION

The present invention is a driving method for preventing a discharge error in the above-mentioned sustain term when a light emitting tube array is driven. The inventors have discovered a cause for generating a discharge error in a light emitting tube array, and a method for overcoming the cause will be described hereinafter.

First, a comparison between the spatial volume of each of the disparage spaces of the light emitting tube array 1 and that of conventional plasma display panels is described. The width of each of their display spaces is first investigated. The interval between partitioning walls of the plasma display panels, which corresponds to the width of the display space, is generally from 80 to 500 nm. The breadth of each of the light emitting tubes 13, which corresponds to the width of each of the display spaces in the light emitting tube array 1, is generally from 0.5 to 5 mm. The interval between the display electrodes, which is the depth length of the display space, is from about 200 to 1500 nm in the plasma display panels, and is from about 0.8 to 10 mm in the light emitting tube array 1. Actually, the length of the depth along which electric discharge is extended is not confined between the display electrodes. In the present investigation, however, only the interval between the display electrodes is adopted for the relative comparison. The height of the partitioning walls of the plasma display panels, which corresponds to the height of the display space, is from 80 to 200 nm, and the height of the light emitting tubes 13 in the light emitting tube array 1 is from 0.3 to 5 mm.

It is understood from the above that the width of each of the display spaces in the light emitting tube array 1 is about 6000 to 10000 times larger than that of the plasma display panels, the depth of each of the display spaces in the light emitting tube array 1 is about 4000 to 70000 times larger than that of the plasma display panels and the height of each of the display spaces in the light emitting tube array 1 is about 4000 to 25000 times higher than that of the plasma display panels. When calculation is made therefrom, the spatial volume of each of the display spaces in the light emitting tube array 1 is substantially several tens of billion times larger than that of each of the discharge spaces in any general plasma display panel.

By use of the same driving method as in plasma display panels at the time of driving the light emitting tube array 1, wherein the spatial volume of its each discharge space is several tens of billion times larger than that in the plasma display panels, there may be generated a discharge error that light emission (discharge) is not caused although a certain discharge space is a discharge space wherein light emission (discharge) is required to be caused. The inventors have searched a cause therefor. As a result, the inventors have found out two main causes.

The first cause is a difference in charge density in each of the discharge spaces. Although the spatial volume of the discharge space is extremely larger than that in plasma display panels, the voltage applied to the light emitting tube array 1 is at largest 1.1 to 2 times the voltage applied to the plasma display panels. The application of a voltage two times the voltage applied to the plasma display panels to the light emitting tube array 1 is not preferred from the viewpoint of the performance of a driver for applying the voltage, or safety. The voltage applied thereto has been becoming smaller in order to aim to make the consumption power smaller. Thus, a display device giving a good display quality without receiving the application of a high voltage has been desired. As described above, the applied voltage is low for the spatial volume of the discharge space. Naturally, therefore, the density of the electric field in the discharge space after discharge is caused is considerably smaller than that in plasma display panels after discharge is caused.

The following describes a matter that this reduction in the electric field density causes a fall in display quality. When generally-used driving in an ADS subfield mode is performed, wall charge is accumulated in the discharge space (cell), which is a light emitting object, in an address term in the driving of the light emitting tube array 1. For this reason, discharge (called address discharge) is generated only in the discharge space, which is light emitting object. In the light emitting tube array 1, however, the electric field density in the discharge space is smaller, as described above; thus, charged particles generated by the address discharge are not easily accumulated on the inner walls of the light emitting tubes 13. In short, the array has a structure wherein the charged particles are not easily turned into wall charge. For this reason, the light-emitting discharge space (cell) in which wall charge is not sufficiently accumulated may not generate discharge-based emission even when a voltage is applied to its display electrodes in the next sustain term. This is because an electric potential sufficient for discharge is not accumulated in the cell.

In the sustain term also, a minute discharge is generated between a large number of charged particles floating in the discharge space and some quantity of the wall charge accumulated in the inner wall in a period when a voltage sufficient for discharge is not applied to the display electrode pair 14 for causing plane discharge, which may be called interval period or idle period. For this reason, the amount of the wall charges does not become a sufficient wall charge amount which should be normally accumulated. Thus, there is caused a problem that the discharge space (cell) wherein light should be emitted will not cause discharge (light emission) in the next application of a voltage to the display electrode pair (in the application of a sustain pulse).

Next, the second cause is described. The second cause is that in light emitting tubes on which fluorescent materials having different colors are painted, the discharge-starting voltages thereof are different from each other by characteristics of the fluorescent materials. It has been understood that according to this matter, spaces wherein discharge is caused and spaces wherein discharge is not caused make their appearance in accordance with the painted fluorescent materials. However, the same fluorescent materials are used in plasma display panels also. The inventors have found out a cause for a matter that in plasma display panels a discharge error is not easily caused on the basis of the fluorescent materials while in the light emitting tube array a discharge error is easily caused on the basis of the fluorescent materials.

With reference to FIG. 4, the cause is described. FIG. 4 is a view which partially illustrates a cross section obtained by cutting one out of discharge spaces in a plasma display panel perpendicularly to the longitudinal direction of partitioning walls. As illustrated in FIG. 4, the panel has a structure wherein partitioning walls 43 are sandwiched between a front substrate 41 and a rear substrate 42 and fluorescent materials 44R, 44G and 44B are painted between the partitioning walls 43 and 43. Various methods for producing the partitioning walls 43 exist at present; in general, known are a method of cutting an original model for the rear substrate 42, which is made of low melting point glass or the like, so as to make convexes and concaves, and using the convex portions as the partitioning walls, a method of printing a partitioning wall material onto the rear substrate 42, which has a flat plane, so as to form the walls on the rear substrate 42, and other methods. However, even if any one of the methods is adopted, it is difficult from the viewpoint of precision to produce all of the partitioning walls 43 to have the very same height. Actually, some of the partitioning walls 43 having the largest height support the front substrate 41, which has been made evident. For this reason, as illustrated in FIG. 4, in an actual plasma display panel, a minute difference in height exits between adjacent ones out of the partitioning walls 43, so that slight gaps b exists between lower ones out of the partitioning walls 43 and the front substrate. This has been understood.

Next, cross sections obtained by cutting the discharge spaces in the light emitting tube array 1 in a direction perpendicular to the longitudinal direction of the light emitting tubes 13 are partially illustrated in FIG. 5. As illustrated in FIG. 5, the light emitting tubes 13 are sandwiched between the front substrate 11 and the rear substrate 12, and the fluorescent material 22R, 22G or 22B is painted onto the inner wall of each of the light emitting tubes 13 at the rear substrate 12 side thereof. Since the light emitting tubes 13 of light emitting tube array 1 are produced by stretching pieces of glass, a difference in height therebetween may be generated by a problem about precision, as illustrated in FIG. 4. However, when the front substrate 11 is rendered a substrate having flexibility, a gap between the front substrate 11 and the light emitting tubes 13 does not substantially exist.

As understood from comparison between FIGS. 4 and 5, in the discharge spaces in the plasma display panel illustrated in FIG. 4, there exist the gaps b each leading to adjacent ones out of the discharge spaces so as to stretch over one of the partitioning walls in the lateral direction in this view (actually, the longitudinal direction of the display electrodes). On the other hand, in the case of the discharge spaces in the light emitting tube array as illustrated in FIG. 5, the discharge spaces are completely partitioned with the walls of the light emitting tubes 13 in the lateral direction in this view (actually, the longitudinal direction of the display electrodes).

Next, a difference between discharge errors based on this difference between the structures is described with reference to FIGS. 6 and 7. FIG. 6 is a view obtained by viewing a situation immediately after discharge is generated in the plasma display panel from the same direction as when the cross section illustrated in FIG. 4 is viewed. FIG. 7 is a view obtained by viewing a situation immediately after discharge is generated in the light emitting tube array from the same direction as when the cross section illustrated in FIG. 5 is viewed. It is supposed that as the fluorescent materials in the individual colors, the same materials are used between the plasma display panel and the light emitting tube array.

For example, it is supposed that in discharge spaces 61 and 71 in which fluorescent materials (22G and 44G) having a green emission color are painted a voltage necessary for discharge is higher than in discharge spaces 62 and 71 in which fluorescent materials (22B and 44B) having a blue emission color are painted. Additionally, it is supposed that voltages are applied thereto in such a manner that the discharge spaces 61 and 62 can emit light in the same timing as the discharge spaces 71 and 72, respectively. In this case, naturally, in the discharge spaces 62 and 72, wherein any discharge is started by a lower voltage, discharges 63 and 73 are generated earlier than in the discharge spaces 61 and 71.

In this case, in the plasma display panel structure, as illustrated in FIG. 6, from the discharge space 62 wherein discharge is earlier generated, charged particles 64 can enter the discharge space 61 wherein discharge is not yet generated through a slight gap existing over a partitioning wall for partitioning the discharge spaces 61 and 62 from each other. When the charged particles 64 enter the adjacent discharge spaces through the gap over the partitioning wall, the voltage difference based on the fluorescent materials becomes small and further a priming effect is produced so that the discharge in the discharge space 61 is promoted.

However, in the light emitting tube array structure, as illustrated in FIG. 7, the discharge spaces are completely partitioned with the walls of the light emitting tubes 13 (in the longitudinal direction of the display electrodes), so that charged particles cannot enter adjacent ones out of the discharge spaces over the walls of the light emitting tubes 13. Thus, in the light emitting tube array, the voltage difference based on the fluorescent materials cannot be made smaller than in the plasma display panel. In the discharge space 71, wherein the voltage necessary for discharge is unfavorably made high by the fluorescent materials, the state that discharge is not easily caused is kept as it is. This is the second cause for generating a discharge error.

In order to solve problems as described above, the present invention is characterized in that in a driving method for a light emitting tube array, a first voltage applied to display electrodes in a sustain term is made higher than any subsequent applied voltage therein, thereby generating discharge easily in the sustain term.

Furthermore, the present invention is characterized in that the pulse width of a first voltage applied to display electrodes in a sustain term is made larger than the pulse width of any subsequent applied voltage therein, thereby generating a first discharge easily in the sustain term.

According to the present invention, a first method of applying voltage to the display electrodes in a sustain term is appropriately devised as described above, so that discharge can be sufficiently generated even in a state that the quantity of wall charge is small since the electric field density is low and further the difference between the discharge starting voltages, based on the fluorescent materials, can be sufficiently cancelled.

### BRIEF DESCRIPTION OF THE DRAWINGS

FIG. 1 is a view illustrating the entire structure of a light emitting tube array.

FIG. 2 is a view illustrating a discharge state of the light emitting tube array.

FIG. 3 shows a part of driving waveforms about which an ADS subfield method is used.

FIG. 4 is sectional view of a plasma display panel.

FIG. 5 is a sectional view of the light emitting tube array.

FIG. 6 is a view illustrating a situation of the plasma display panel after discharge is caused.

FIG. 7 is a view illustrating a situation of the light emitting tube array after discharge is caused.

FIG. 8 is a view illustrating the structure of electrodes and drivers in the light emitting tube array.

FIG. 9 is a chart showing the structure of one field about a driving method in an ADS subfield mode.

FIG. 10 is a chart showing an example of driving waveforms in the present invention.

FIG. 11 is a chart illustrating an application example of the waveforms in the present invention.

FIG. 12 is a chart illustrating an application example of the waveforms in the present invention.

FIG. 13 is a chart illustrating an application example of the waveforms in the present invention.

FIG. 14 is a chart illustrating an application example of the waveforms in the present invention.

FIG. 15 is a chart illustrating an application example of the waveforms in the present invention.

FIG. 16 is a chart illustrating an application example of the waveforms in the present invention.

FIG. 17 is a chart illustrating an application example of the waveforms in the present invention.

### BEST MODE FOR CARRYING OUT THE INVENTION

Examples of the present invention will be described.

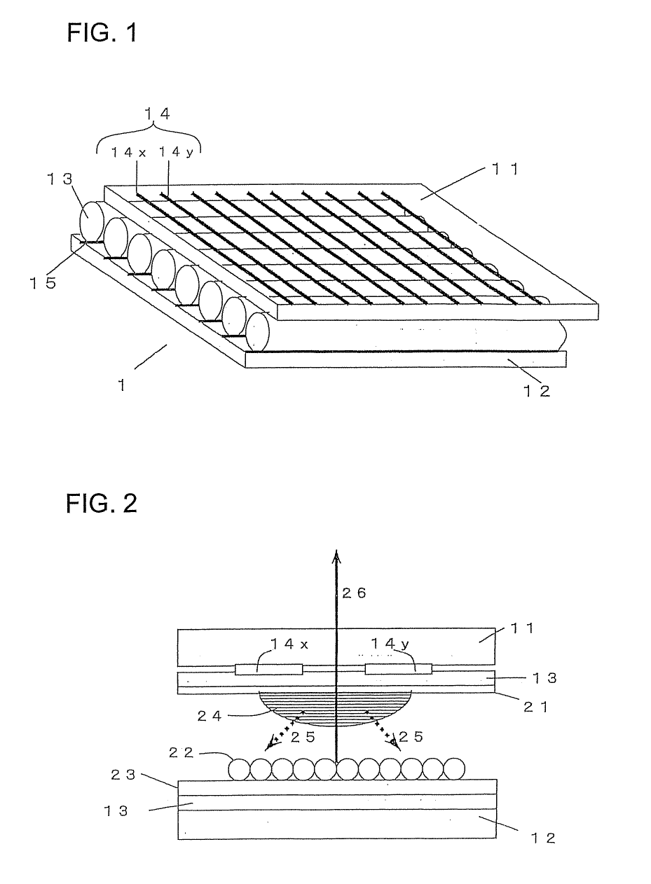

The structure of a light emitting tube array used in the present invention is a structure illustrated in FIGS. 1 and 2. Specifically, as illustrated in FIG. 1, a plurality of slender light emitting tubes 13 are arranged in parallel to each other, and the plurality of light emitting tubes 13 are sandwiched between a front substrate 11 and a rear substrate 12. In each of the light emitting tubes 13, a fluorescent material layer 22 is formed, and Ne—Xe is airtightly put. Address electrodes 15 are formed at the light emitting tube 13 side of the rear substrate 12, and are located in the longitudinal direction of the light emitting tube array 1. Furthermore, display electrode pairs 14 are located in a direction which crosses the address electrodes 15 on the front substrate 11.

The display electrodes 14x and 14y are preferably made of transparent electrodes of ITO or the like, and made of bus electrodes of metal, or preferably made of a mesh-form metal film having a plurality of openings. Since the address electrodes 15 are arranged on the rear substrate 12, which is not required to transmit light, the electrodes 15 are preferably made only of metal. As the material of each of the electrodes, Ag, a laminate structure of Cr/Cu/Cr, or some other material is used. These electrodes are formed by a printing method, a vapor deposition method or some other method known in the art. It is preferred to arrange, inside each of the light emitting tubes 13, a board 12 having an upper surface on which the fluorescent material layer 13 is formed.

On the inner wall of the light emitting tube 13 at the display electrode pair side thereof, a protecting layer 21 made of an MgO film is formed.

When this light emitting tube array 1 is two-dimensionally viewed, cross portions of the address electrodes 15 and the display electrode pairs 14 become unit light emitting regions. Display is performed in an ADS subfield mode having: address terms when the display electrodes 14y are used as scan electrodes and address discharge is generated between the scan electrodes and the address electrodes 15 to select one or more out of the light emitting regions; and sustain terms when wall charge formed in the light emitting tube inner wall(s) of the region(s) in company with the address discharge is used to generate display discharge in the display electrode pair(s) 14.

FIG. 8 is an explanatory view illustrating a state that the electrodes of the light emitting tube array illustrated in FIG. 1 are connected to drivers (driving circuits). In this view, 1 represents the light emitting tube array; 81, a scan driver for applying scan voltage to the display electrodes 14y which also function as scan electrodes; 82, a sustain driver for applying voltage for sustain discharge to each of the display electrodes 14x and the display electrodes 14y; and 83, an address driver for applying voltage to the address electrodes 15.

As illustrated in this view, the display electrodes 14y, which also function as scan electrodes, are connected through the scan driver 81 to the sustain driver 82. The display electrodes 14x are connected to the sustain driver 82. The address electrodes 15 are connected to the address driver 83. The application of voltage is attained by each of the drivers.

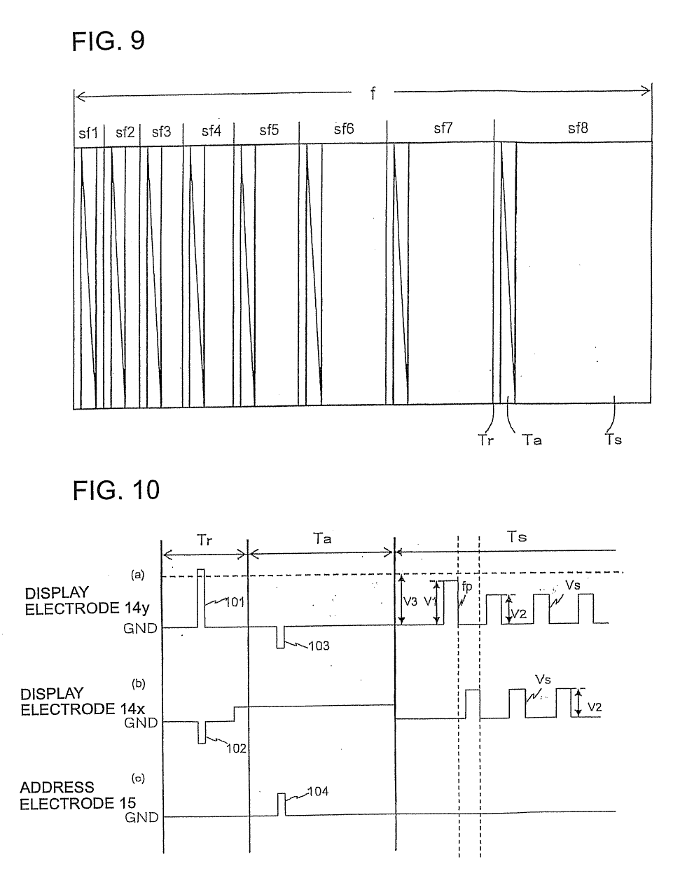

FIG. 9 is an explanatory chart showing a gradation display method of the light emitting tube array 1. This chart shows a term in which a single image is displayed. This term is usually called one frame (f in the chart). One frame is composed of plural fields in some cases; thus, in the following description, this term is used as one field. This chart is a chart showing a frame structure in the ADS subfield mode, which is a typical mode for gradation display. In order to apply the mode to an actual display panel to obtain a good image quality, voltage may be applied in terms that are more finely divided.

As the gradation display method of the light emitting tube array 1, a known method that is usually used in the art is used, an example of the method being a method used in a plasma display device of a three-electrode plane-discharge reflection type.

A rough explanation is as follows: The one field f is composed of eight subfields sf1 to sf8 to which weights corresponding to numbers of 1, 2, 4, 8, 16, 32, 64 and 128, respectively, are given, so that the subfields sf1 to sf8 have periods different from each other. Each of the subfields sfn is composed of: a reset term Tr when the state of wall charge on the inner walls of the light emitting tubes 13 corresponding to all the cells which constitute a screen is adjusted in such a manner that discharge will be made uniform in an address term subsequent to this term; the address term Ta, which is a term when wall charge is formed on the inner walls of the light emitting tubes 13 corresponding to the cells where light is to be emitted, so as to memorize data; and a sustain term Ts when light emission from the cells where the wall charge is formed in the address term Ta is maintained.

In the light emitting tube array drivable in the AC mode, the following method is used in order to specify the cells where light emission is to be caused or perform light emission display: a method of accumulating wall charge in the light emitting tube inner walls which confine the cells. Main portions where this wall charge is accumulated are moieties of the light emitting tube inner walls which face the display electrodes 14y and moieties of the light emitting tube inner walls which face the address electrodes 15. Between these discharge electrode moieties, discharge is generated.

First, in the reset term Tr, discharge (reset discharge) is generated between the display electrodes 14x and the display electrodes 14y in all of the cells, so as to turn wall charge in all of the cells into a state that discharge will be uniform in the subsequent address term Ta. In the address term Ta, the display electrodes 14y are used as scan electrodes, a scan pulse is successively applied to the lines. Additionally, in synchronization therewith, address pulses are applied to some of the address electrodes 15. In this way, discharge is generated inside the light emitting tubes in the vicinity of the portions where the display electrodes 14y of the cells where light emission is to be caused and the address electrodes 15 thereof cross at right angles. As a result, wall charge is formed in the selected cells. In the reset term Tr, voltage is applied to the address electrodes 15 also, so that the quantity of the wall charge may be adjusted.

In the sustain term Ts, sustain pulses having a voltage at which discharge can be generated only in the cells where the wall charge is formed are applied alternately to the display electrodes 14x and the display electrodes y adjacent thereto, thereby generating display discharge to maintain the light emission from the cells.

The length of the sustain term Ts in the subfield sfn is beforehand decided in accordance with the weight of the subfield sfn. In the sustain term Ts, sustain pulses for sustain discharge are applied, in a number corresponding to the weighting number, to the display electrodes 14x and the display electrodes 14y across these display electrodes. Accordingly, the gradation of the image to be displayed can be expressed by selecting subfields sfn about which their light emission maintaining numbers correspond to the brightness.

In FIG. 9, shown has been an example wherein the subfields sft are arranged in order from the subfield wherein the sustain pulse number is smallest (the weighting number is smallest). However, the arrangement order of the subfields sfn may be varied at will.

The description has been made about an example wherein address discharge for forming wall charge is generated in the cells where light is required to be emitted in the address term Ta. This is an example wherein the so-called writing address mode is adopted to specify the cells where light emission is to be caused. The cells where light emission is to be caused may be specified by the so-called erasing address mode, in which in the reset term Tr the array is turned into a wall charge state that discharge will be caused in all the cells in the sustain term Ts and subsequently address discharge will be generated for erasing the wall charge in the cells where light emission is not required to be caused.

The following will describe examples of the driving method of the present invention.

### EXAMPLES

FIG. 10 (a), (b) and (c) sections show voltage waveforms applied to any one of the display electrodes 14x, any one of the display electrodes 14y and any one of the address electrodes 15, respectively, in any one of the subfields. FIG. 10(a) section shows a voltage waveform applied to any one of the display electrodes 14y which also function as scan electrodes, FIG. 10(b) section shows a voltage waveform applied to any one of the display electrodes 14x, which are combined with the display electrodes 14y to constitute pairs to generate display discharge, and FIG. 10(c) section shows a voltage waveform applied to any one of the address electrodes 15.

In the reset term Tr, reset pulses 101 and 102 having positive voltages are substantially simultaneously applied to the display electrode 14x and the display electrode 14y, the pulses 101 and 102 being pulses to make the difference in electric potential between these display electrodes higher than a discharge starting voltage V3. In the address term Ta, scan pulses 103 are successively applied to the display electrode 14y, and during the application an address pulse 104 for specifying one of the cells is applied to the address electrode 15. In the sustain term Ts, a first sustain pulse fp having a higher voltage V1 than a voltage V2 of sustain pulses Vs, which will be subsequently repeated, is first applied. V1 is preferably 1.3 times or more larger than V2. When the sustain pulses Vs have, for example, a voltage of 200 V, the first sustain pulse fp has a voltage of 260 V or more.

In this way, the first sustain pulse fp is caused to have a higher voltage than that of the subsequent sustain pulses Vs, whereby a first discharge in the sustain term TS is easily generated.

After the application of the first sustain pulse fp, the sustain pulses Vs having the same electric potential are alternately applied to the display electrode 14x and the display electrode 14y. Ground voltage (GND) is a reference electric potential of the present light emitting tube array 1. The reference electric potential is not limited to the ground electric potential (0 volt).

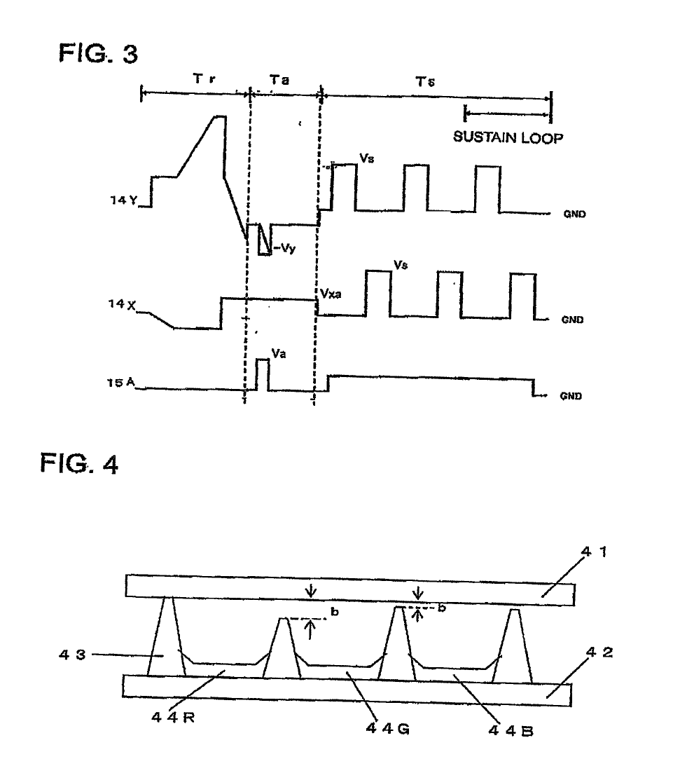

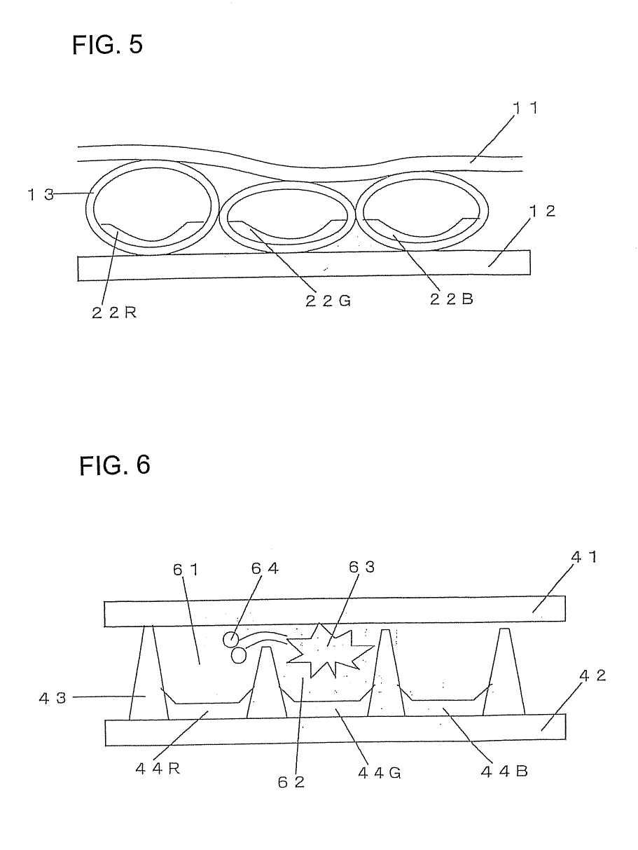

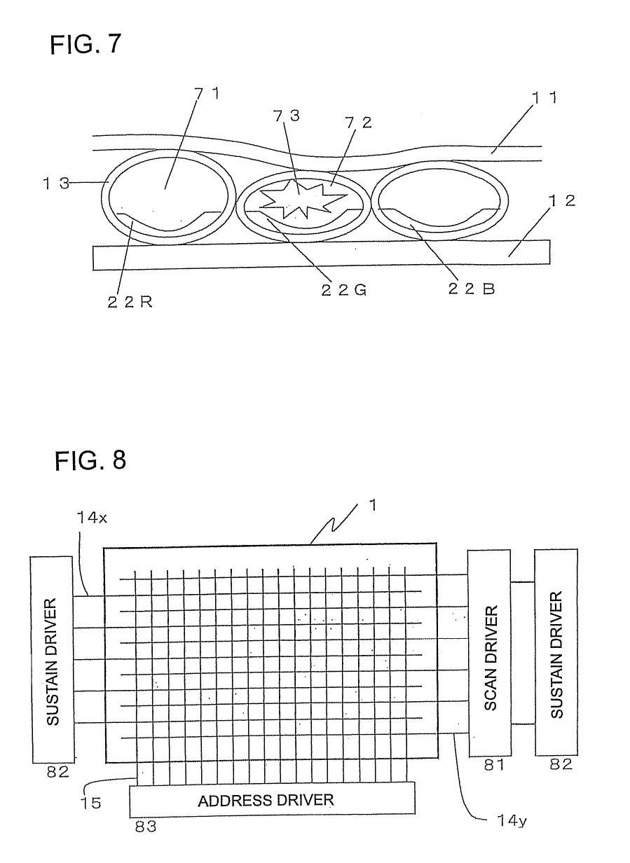

The voltage application in each of the different kind terms and a situation of wall charge in company therewith will be described hereinafter. In the reset term Tr, the reset pulses 101 and 102 applied to the display electrodes 14y and 14x are two out of pulses to be applied in order to erase wall charge accumulated on the inner walls of the cells which emitted light in the previous subfield and then make all the cells into an even wall charge state (a substantially zero state). When the reset pulses 101 and 102 are applied, a large discharge is generated on the inner wall of the light emitting tube corresponding to the location between the display electrode 14y and the display electrode 14x in the rise-up of the reset pulses 101 and 102, so that a large quantity of wall charge is formed. Thereafter, an electric field is generated in the vicinity of the large-quantity wall charge. The resultant potential difference exceeds the discharge starting voltage, so that the so-called self-erasing discharge is caused. In this way, the wall charge on the inner walls near the electrodes and on the fluorescent material layer is spatially neutralized and erased. As a result, the charge in the cell becomes substantially zero. About the waveforms applied to the reset term, other variation examples are present; the wall charge can be set into an initial state by using a lamp wave wherein the voltage rises slowly until the voltage exceeds the discharge starting voltage, as shown in FIG. 3, or using a waveform obtained by combining a lamp wave wherein the voltage rises with a lamp wave wherein, subsequently to the former lamp wave, the voltage with a reverse phase decreases, or some other waveform.

In the address term Ta after the application of the reset pulses 101 and 102, a scan pulse 103 having negative polarity is applied to the display electrode 14y. In the case of applying, at this application time, an address pulse 104 having positive polarity to the address electrode 15, writing discharge (address discharge) is caused in the cell corresponding to the intersection of the display electrode 14y and the address electrode 15. In the address term Ta, a voltage negative relatively to the ground electric potential is applied to the display electrode 14y; therefore, after the address discharge, positive wall charge is accumulated on the inner wall of the light emitting tube facing the display electrode 14y. This cell becomes a light emitting cell.

In the meantime, at the time of applying the scan pulse 103 to the display electrode 14y, no writing discharge is caused if the address electrode 15 is at the ground electric potential. Thus, no wall charge is accumulated so that the cell becomes a non light-emitting cell.

When in the sustain term Ts the first sustain pulse fp is applied, as a pulse having positive polarity reverse to that of the scan pulse 103, to the display electrode 14y, there is generated an effective voltage difference which is the electric potential difference formed by the wall charge accumulated by the discharge in the address term TA plus the voltage V1 of the first sustain pulse. When the effective voltage difference is set to a value which largely exceeds the discharge starting voltage V3, more preferably when the first sustain pulse voltage V1 is set to a value slightly lower than the discharge starting voltage V3, a first discharge in the sustain term TS is easily generated. In an example, it is advisable to set the first sustain voltage V1 to 260 V and set the discharge starting voltage V3 to 270 V. Of course, it is necessary that the effective voltage difference between the subsequent sustain pulses Vs and the wall charge accumulated by the discharge in the sustain term TS also exceeds the discharge starting voltage V3; thus, the sustain voltage V2 is set to, for example, 200 V (a design in which the wall charge has an electric potential of about 80 V).

As illustrated in FIG. 10(c) section, in the present example, the electric potential of the address electrode 15 is kept at the ground electric potential in the sustain term Ts, when discharge is maintained. In the example, the reference electric potential is set to the ground electric potential; however, this electric potential is not limited to the ground electric potential. A slight electric potential may be given so as to attain plane discharge effectively in the sustain term Ts. It is sufficient that the reference electric potential is an electric potential which results in causing the effective electric potential difference between the electric potential of the display electrode 14y or 14x and the electric potential produced by the wall charge to exceed the discharge starting voltage V3.

In order to maintain the discharge in the sustain term, the sustain pulses Vs are alternately applied to the display electrodes 14y and 14x repeatedly, as illustrated in FIGS. 10(a) and (b) sections.

Usually, the sustain pulses Vs (V2) applied to the sustain term Ts of the light emitting tube array 1 are at about 200 to 240 volts. The address pulse 104 applied in the address term Ta is at about 100 volts.

According to the adoption of the present example, discharge is generated by applying, as a first pulse in the sustain term, a first sustain pulse fp having a wave height value 1.3 times that of subsequent sustain pulses if wall charge is accumulated in only a small quantity in the address term Ta. Naturally, in order for the cells where no wall charge is accumulated not to cause discharge, it is preferred to make the electric potential V1 of the first sustain pulse fp slightly lower than the discharge starting voltage V3. Such driving makes it possible to decrease discharge errors in the sustain term TS in the light emitting tube array 1.

In FIG. 10, the wave height value of the first pulse is made higher than that of the subsequent sustain pulses Vs; however, some early pulses may be as follows: pulses wherein their wave height values gradually become lower from the first pulse may be applied, so that the last of the applied pulses becomes a pulse having the wave height value of V2.

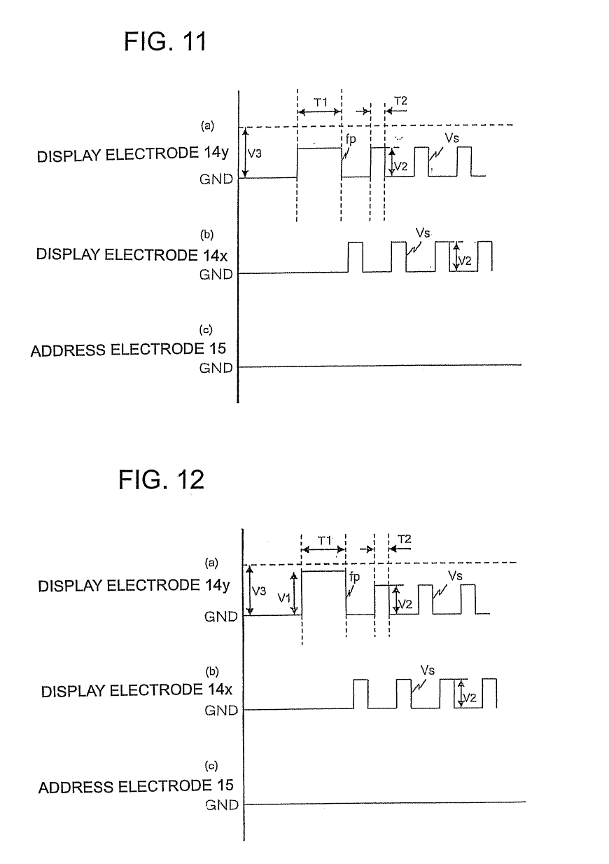

As the waveform of the first sustain pulse fp in the sustain term Ts, various waveforms can be supposed. Application examples thereof are shown in FIG. 11 to FIG. 17. The reset term Tr and the address term Ta in each of FIGS. 11 to 17 are the same as in FIG. 10. Thus, they are omitted in FIGS. 11 to 17.

Waveforms shown in FIG. 11 are waveforms about which the pulse width of a first sustain pulse fp is made larger than the width of subsequent sustain pulses Vs in the sustain term Ts. When the sustain pulse width is made large in this way, the period in which voltage is applied becomes long so that the probability of discharge is made high. The width of the first sustain pulse fp is preferably two times or more the width of the sustain pulses Vs.

However, if the pulse widths of all sustain pulses in all sustain terms Ts are made large, the driving time becomes long and the frequency (the number of applied sustain pulses) cannot be made high to result in a problem that a trouble is caused in brightness or gradation expression. In the present invention, the width of the first pulse in the sustain term Ts is made large, thereby decreasing discharge errors without causing any trouble in brightness or gradation expression.

FIG. 12 is a chart wherein the wave height value of a first sustain pulse fp in the sustain term TS is made higher than that of subsequent sustain pulses Vs and the pulse width of the first sustain pulse fp is made larger than that of the subsequent sustain pulses Vs.

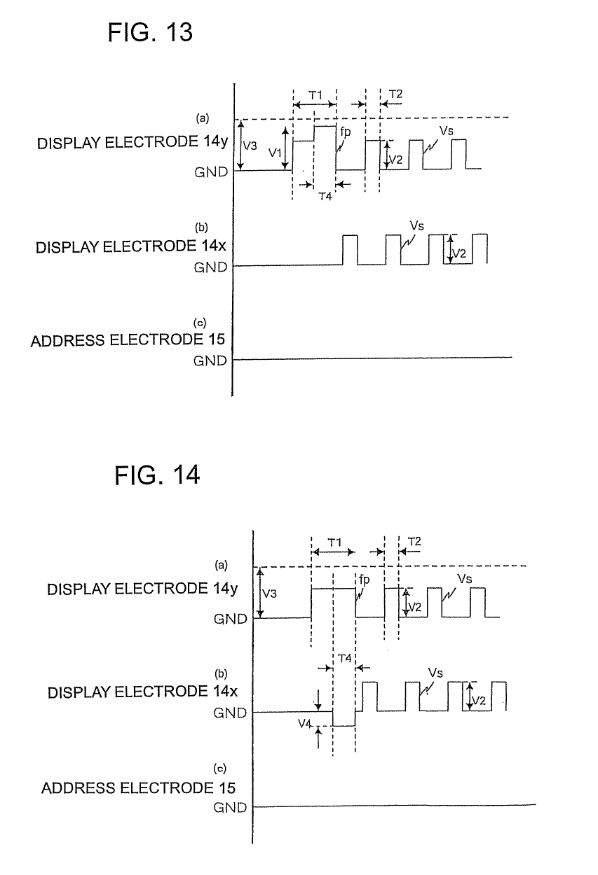

FIG. 13 shows the following pulses: a first sustain pulse fp in the sustain term TS has two wave height values, and the first half of the first sustain pulse fp has the same wave height value as subsequent pulses and the second half thereof has a higher wave height value than the first half. In the case of using the waveforms in FIGS. 10 to 12, in the cells wherein the driving voltage is low, there is a probability of the following: a discharge error that light is emitted although the cells are not cells wherein light should be emitted. For this reason, the applying timing of an additional voltage (V1-V2) is staggered as illustrated in FIG. 13. In this way, discharge is caused at V2 (the first half of the first sustain pulse fp) in the cells wherein the driving voltage is low, so that wall charge having reverse polarity is formed. Thus, in the second half, when the additional voltage is applied, no discharge is caused. Of course, discharge is not caused, either, at the time of applying the subsequent sustain pulses Vs.

FIG. 14 is a chart wherein a voltage corresponding to the additional voltage in FIG. 13 (V4, V1-V2 in FIG. 13) is applied, as a reverse electric potential, to the display electrode 14x. It is needless to say that the same advantageous effects as in FIG. 13 are obtained according to this waveform also.

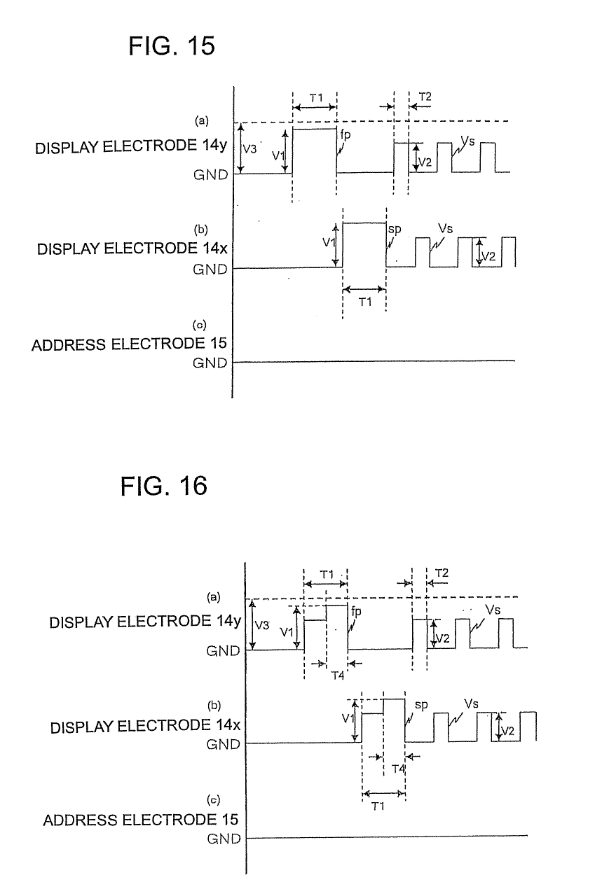

FIG. 15 is a chart wherein the width of first two pulses in the sustain term Ts are made larger than that of subsequent sustain pulses Vs. In FIG. 15, the pulse width of a first sustain pulse fp applied to the display electrode 14y and that of a second sustain pulse sp applied to the display electrode 14x are set so as to be larger than that of subsequent pulses. The width of the first sustain pulse fp is equal to that of the second sustain pulse sp; however, the width of the second sustain pulse sp may be smaller than that of the first sustain pulse fp for the following reason: when discharge is generated by the application of the first sustain pulse fp, the discharge is in a highly stable state. Sustain pulses about which their widths gradually become smaller in such a way may be applied in turn from the start.

FIG. 16 is a chart wherein a first sustain pulse fp in the sustain term Ts and a second sustain pulse sp therein each have two wave height values, and the wave height value of the second half of each of the pulses is higher than that of the first half. In FIG. 16 also, the width of the second sustain pulse sp may be smaller than that of the first sustain pulse fp. Of course, the wave height value of the first sustain pulse fp may also be lower than that of the second sustain pulse sp.

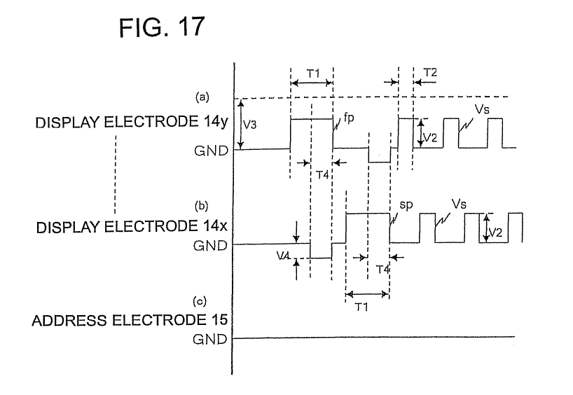

FIG. 17 is a chart wherein a voltage corresponding to the additional voltage in FIG. 16 (V4, V1-V2 in FIG. 16) is applied to the other of the electrodes. It is needless to say that according to this wave form also, the same advantageous effects as in FIG. 16 are obtained.

### INDUSTRIAL APPLICABILITY

The present invention relates to an improvement in a method for driving a light emitting tube array composed of a front substrate on which a display electrode pair is formed, a rear substrate on which an address electrode is formed, and a plurality of light emitting tubes sandwiched between the two substrates, wherein memory display is attained with a small generation-frequency of discharge errors.

### DESCRIPTION OF REFERENCE NUMBERS

1 light emitting tube array
11 front substrate
12 rear substrate
13 light emitting tubes
14 display electrode pairs
15 address electrodes
21 protecting layer
22 fluorescent material layer
23 board
24 discharge
25 ultraviolet rays
26 visible rays
41 front substrate of a plasma display panel
42 rear substrate of the plasma display panel
43 partitioning walls of the plasma display panel
61, and 62 discharge spaces in the plasma display panel
63, and 73 discharges
64 charged particles
71 and 72 discharge spaces in the light emitting tube array
81 scan driver
82 sustain driver
83 address driver

1. A method for driving a light emitting tube array wherein a fluorescent material layer is arranged on an inner wall of each light emitting tube sandwiched between a front substrate and a rear substrate, a discharge gas is airtightly put therein, a plurality of electrodes formed for generating discharge in the light emitting tube are formed on the front substrate and the rear substrate, and driving is performed in a time-sharing manner on the basis of an address term when discharge cells confined in the light emitting tube are selectively addressed, and a sustain term when display is performed in the cells all at once,
wherein the width of a sustain pulse applied first in the sustain term is larger than the width of any subsequent sustain pulse therein.

2. The method for driving a light emitting tube array according to claim 1, wherein the width of the sustain pulse applied first is two or more times the width of the subsequently-repeated sustain pulses.

3. A method for driving a light emitting tube array wherein a fluorescent material layer is arranged on an inner wall of each light emitting tube sandwiched between a front substrate and a rear substrate, a discharge gas is airtightly put therein, a plurality of electrodes formed for generating discharge in the light emitting tube are formed on the front substrate and the rear substrate, and driving is performed in a time-sharing manner on the basis of an address term when discharge cells confined in the light emitting tube are selectively addressed, and a sustain term when display is performed in the cells all at once,
wherein the wave height value of a sustain pulse applied first in the sustain term is larger than the wave height value of any subsequently-repeated sustain pulse therein.

4. The method for driving a light emitting tube array according to claim 3, wherein the wave height value of the sustain pulse applied first is 1.3 or more times the wave height value of the subsequently-repeated sustain pulse.

5. The method for driving a light emitting tube array according to claim 1, wherein the wave height value of the sustain pulse applied first becomes high in the second half of the pulse.

6. The method for driving a light emitting tube array according to claim 3, wherein the wave height value of the sustain pulse applied first becomes high in the second half of the pulse.
